(19) United States
(12) Patent Application Publication
(10) Pub. No.: US 2014/0210195 A1
(43) Pub. Date: Jul. 31, 2014

(54) WHEELED VEHICLE HAVING A SEAT WITH A LATERAL RESTRAINING MEMBER

(71) Applicant: BOMBARDIER RECREATIONAL PRODUCTS INC., Valcourt (CA)

(72) Inventors: Daniel NADEAU, St-Denis-de-Brompton (CA); Dany ST-PIERRE, Sherbrooke (CA); Didier DUBOIS, Sherbrooke (CA)

(73) Assignee: BOMBARDIER RECREATIONAL PRODUCTS INC., Valcourt (CA)

(21) Appl. No.: 14/164,826

(22) Filed: Jan. 27, 2014

Related U.S. Application Data
(60) Provisional application No. 61/758,828, filed on Jan. 31, 2013.

(51) Int. Cl. B60R 21/13; B60R 21/02

(52) U.S. Cl. CPC B60R 21/13; B60R 21/02
USPC 280/756; 280/727

(57) ABSTRACT

A vehicle has a frame, at least three wheels, a motor, a cockpit area, and a seat. The seat has a seat base and a backrest and is movable along a longitudinal direction of the vehicle between first and second positions. The first position is closer to a front of the vehicle than the second position. A lateral restraining member is fixed to the seat on one side of the seat. At least a portion of the lateral restraining member is disposed higher than the seat base and forward of the backrest. The lateral restraining member is movable with the seat between the first and second positions.

### CROSS-REFERENCE

The present application claims priority to U.S. Provisional Patent Application No. 61/758,828, filed Jan. 31, 2013, the entirety of which is incorporated herein by reference.

### TECHNICAL FIELD

The present technology relates generally to a wheeled vehicle having a seat with a lateral restraining member.

### BACKGROUND

Recreational utility vehicles (RUVs) generally have an open cockpit area with side-by-side seating. They are sometimes referred to as side-by-side All-Terrain Vehicles (ATVs).

The open cockpit area is protected by a roll cage disposed above the cockpit area.

The driver and the passenger enter and exit (ingress and egress) the vehicle through lateral passages, as is traditionally done on automobiles.

Some RUVs are provided with lateral restraining members connected to the roll cage and the frame at the back of the lateral passages and which extend forward therefrom into the lateral passages to provide a rigid structure that the driver and passenger can lean against to increase stability and comfort.

In some vehicles, in order to accommodate drivers of different heights, adjustable seats are provided that can be moved forward and back in a number of positions. However, when the seats are moved to a forward position, the driver or passenger may be too far forward for the corresponding lateral restraining member to allow the driver or passenger to lean against it.

One solution consists in providing lateral restraining members that extend further forward in the lateral passages. However, such lateral restraining members could hinder ingress and egress of the driver and passenger from the vehicle, especially for tall drivers and passengers.

Therefore, there is a need for providing a wheeled vehicle with a structure that a driver or passenger can lean against in many seat positions without hindering ingress and egress of the driver or passenger too much.

### SUMMARY

It is an object of the present technology to ameliorate at least some of the inconveniences present in the prior art.

In one aspect, embodiments of the present technology provide a vehicle provides a frame, at least three wheels connected to the frame, a motor supported by the frame and operatively connected to at least one of the wheels, a cockpit area defined in the frame, and a seat disposed in the cockpit area. The seat has a seat base and a backrest. The seat is movable along a longitudinal direction of the vehicle between a first position and a second position. The first position is closer to a front of the vehicle than the second position. A lateral restraining member is fixed to the seat on the one side of the seat. At least a portion of the lateral restraining member is disposed higher than the seat base and forward of the backrest. The lateral restraining member is movable with the seat between the first and second positions.

In an additional aspect, the lateral restraining member is fixed to the backrest.

In a further aspect, the backrest includes a backrest frame and a cushion connected to the backrest frame. The lateral restraining member is connected to the backrest frame.

In an additional aspect, the seat has a headrest disposed above the backrest. The lateral restraining member is disposed lower than the headrest.

In a further aspect, the portion of the lateral restraining member disposed above the seat base and forward of the backrest has a portion disposed above a vertical center of the backrest and another portion disposed below the vertical center of the backrest.

In an additional aspect, the lateral restraining member is a first lateral restraining member. The vehicle also has a second lateral restraining member fixed to the frame. The second lateral restraining member is disposed on the one side of the seat. The first lateral restraining member is disposed at least in part laterally between the seat and the second lateral restraining member.

In a further aspect, a height of the second lateral restraining member is greater than a height of the first lateral restraining member.

In an additional aspect, a length of the second lateral restraining member is greater that a length of the first lateral restraining member.

In a further aspect, at least a portion of the second lateral restraining member is disposed forward of the backrest when the seat is in the first position.

In an additional aspect, a front end of the second lateral restraining member is disposed forward of a front end of the first lateral restraining member when the seat is in the second position. The front end of the second lateral restraining member is disposed rearward of the front end of the first lateral restraining member when the seat is in the first position.

In a further aspect, a roll cage is connected to the frame. The roll cage covers at least in part the cockpit area. An upper end of the second lateral restraining member is connected to the roll cage and a lower end of the second lateral restraining member is connected to the frame.

In an additional aspect, the lateral restraining member is a generally U-shaped tube.

In a further aspect, the vehicle has two lateral sides. The cockpit area is disposed between the two lateral sides. At least the lateral side on the one side of the seat defines a lateral passage adapted to allow ingress and egress of a rider to and from the cockpit area.

In an additional aspect, a roll cage is connected to the frame. The roll cage covers at least in part the cockpit area. A lateral flexible cover selectively extends at least partially across the lateral passage defined by the lateral side on the one side of the seat. The lateral flexible cover is connected to the roll cage.

In a further aspect, when the seat is in the first position and the lateral flexible cover extends across the lateral passage, a portion of a projection of the lateral restraining member on a longitudinally extending vertical plane overlaps a portion of a projection of the lateral flexible cover on the longitudinally extending vertical plane.

In an additional aspect, the seat is a left seat, the one side of the seat is the left side of the seat and the lateral restraining member is a left lateral restraining member. The vehicle also has a right seat disposed in the cockpit area to a right of the left seat. The right seat has a seat base and a backrest. The right seat is movable along the longitudinal direction of the vehicle between a third position and a fourth position. The third position is closer to the front of the vehicle than the fourth position. A right lateral restraining member is fixed to the seat on the right side of the seat. At least a portion of the right lateral restraining member is disposed above the seat base of the right seat and forward of the backrest of the right seat. The right lateral restraining member is movable with the seat between the third and fourth positions. A steering device is disposed in front of one of the left and right seats. The steering device is operatively connected to at least one of the wheels.

In a further aspect, the at least three wheels is two front wheels and two rear wheels.

In an additional aspect, a projection of the first lateral restraining member on a longitudinally extending vertical plane when the seat is in the second position is disposed inwardly of a projection of the second lateral restraining member on the longitudinally extending vertical plane.

In a further aspect, the lateral restraining member is fixed to the seat at a position where a top of the second lateral restraining member is vertically lower than a top of a shoulder of a 50^{th} percentile North-American adult male sitting on the seat.

In an additional aspect, a top of the second lateral restraining member is less than 52 centimeters above a top rear portion of the seat base.

For purposes of this application the term “recreational utility vehicle” (RUV) refers to an “opened” wheeled vehicle (contrary to a pickup truck which is a “closed” vehicle due to its closed passenger cabin) designed for off-road use which usually has side-by-side seating.

Also, terms related to spatial orientation such as forwardly, rearward, front, rear, upper, lower, left, and right, are as they would normally be understood by a driver of the vehicle sitting thereon in a normal driving position.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

Further features and advantages of the present technology will become apparent from the following detailed description, taken in combination with the appended drawings, in which:

FIG. 1 is a left side elevation view of an RUV, with some fairings removed for clarity;

FIG. 2 is a perspective view, taken from a front, left side, of the RUV of FIG. 1;

FIG. 3 is a top plan view of the RUV of FIG. 1;

FIG. 4 is a perspective view, taken from a rear, left side of a driver seat of the RUV of FIG. 1;

FIG. 5 is a left side elevation view a roll cage, lateral flexible cover, driver seat and some fairings of the RUV of FIG. 1, with the seat in a rearmost position;

FIG. 6 is a left side elevation view of the roll cage, driver seat and a fairing of the RUV of FIG. 1, with the seat in the rearmost position;

FIG. 7 is a left side elevation view a roll cage, lateral flexible cover, driver seat and some fairings of the RUV of FIG. 1, with the seat in a forwardmost position;

FIG. 8 is a left side elevation view of the roll cage, driver seat and a fairing of the RUV of FIG. 1, with the seat in the forwardmost position; and

FIGS. 9 and 10 illustrate various dimensions of a 50^{th} percentile North American adult male.

### DETAILED DESCRIPTION

The present lateral restraining member will be described with respect to a recreational utility vehicle (RUV). However it should be understood that the present lateral restraining member could be used on other types of on-road and off-road vehicles having at least three wheels.

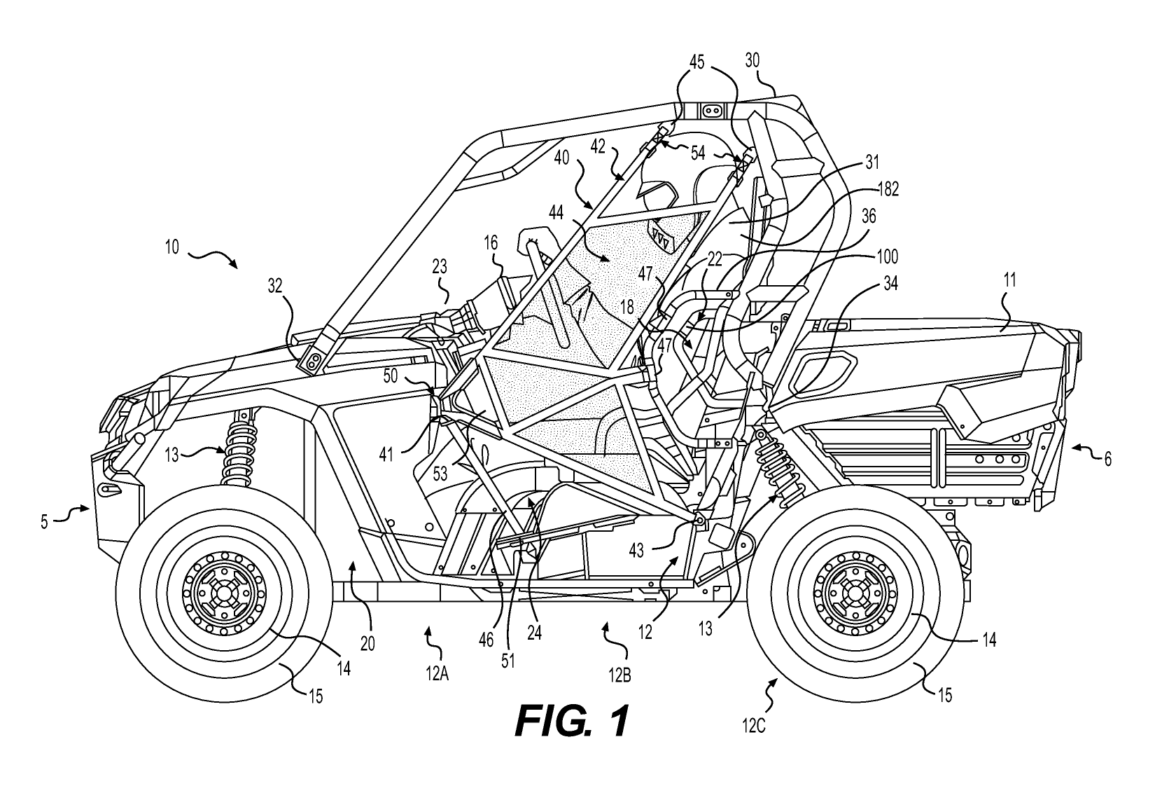

FIGS. 1 to 3 illustrate an RUV 10 having a front end 5, a rear end 6, and two lateral sides 7 (left and right). The RUV 10 includes a frame 12 to which a vehicle body is mounted. The frame 12 has a front portion 12A, a middle portion 12B and a rear portion 12C. A pair of front wheels 14 is suspended from the front portion 12A of the frame 12 via front suspension 13. A pair of rear wheels 14 is suspended from the rear portion 12C of the frame 12 via rear suspension 13. Each of the four wheels 14 has a tire 15. It is contemplated that the RUV 10 could have six or more wheels. A cockpit area 22 is disposed in the middle portion 12B of the frame 12. The cockpit area 22 comprises two seats 18 (left and right). Each seat 18 has a seat base 17 and a backrest 19. The seats 18 are mounted laterally beside each other to accommodate a driver and a passenger of the RUV 10. The seats 18 are bucket seats. It is contemplated that the seats 18 could be other types of recumbent seats. It is contemplated that the RUV 10 could have two rows of two seats 18. The seats 18 will be described in more detail below.

The cockpit area 22 is open at the two lateral sides 7 of the RUV 10, forming two lateral passages 24 (left and right), through which the riders can ingress and egress the RUV 10. A lateral cover 40 is selectively disposed across each lateral passage 24. The lateral cover 40 extends vertically from the roll cage 30 to a point vertically lower than the seat base 17. It is contemplated that only one of the two lateral passages 24 could be selectively partially covered by a lateral cover 40. The lateral covers 40 are made of flexible straps 42 and flexible panels 44 of meshed material. When the riders are riding the RUV 10, the lateral covers 40 are intended to be disposed across the lateral passages 24. However, when the riders are not riding the RUV 10 and they desire either ingress or egress the cockpit area 22, the lateral covers 40 are opened to clear the lateral passages 24. The lateral covers 40 will be described in greater detail below.

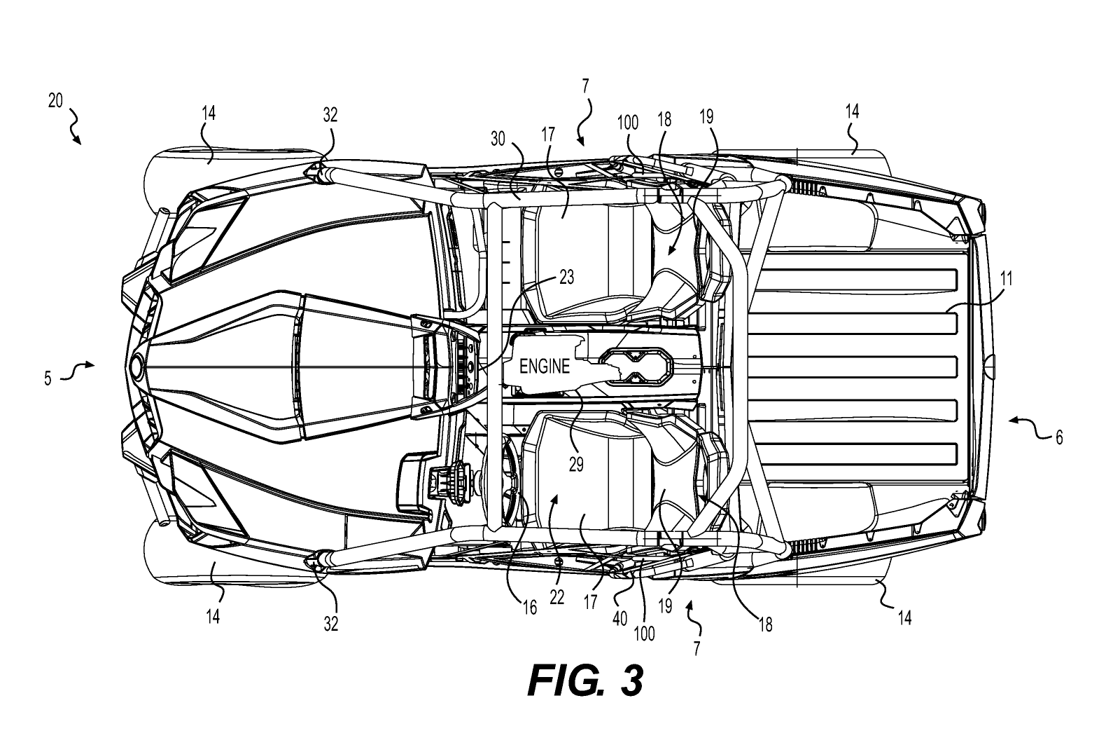

A roll cage 30 is connected to the frame 12 and is disposed above the cockpit area 22. The roll cage 30 is an arrangement of metal tubes which contributes to protecting the riders. The roll cage 30 has several attachment points to the frame 12. Toward the front 5 of the RUV 10, the roll cage 30 connects to the frame 12 at front attachment points 32 (left and right). The front attachment points 32 are located longitudinally between a roll axis of the front wheels 14 and a forwardmost point of the seat bases 17 of the seats 18. Toward the rear 6 of the RUV 10, the roll cage 30 connects to the frame 12 at rear attachment points 34 (left and right). The rear attachment points 34 are located longitudinally between a roll axis of the rear wheels 14 and a rearmost point of the seat bases 17 of the seats 18. A pair of lateral restraining members 36 is fixed to each side of a rear part of the roll cage 30 and to the frame 12. As best seen in FIG. 3, the left lateral restraining member 36 is disposed to the left of the left seat 18 and the right lateral restraining member 36 is disposed to the right of the right seat 18. The lateral restraining members 36 extend forward from the rear part of the roll cage 30 partially into the lateral passages 24. The lateral restraining members 36 will be described in more detail below.

A steering assembly 16 including a steering wheel is disposed in front of the left seat 18. It is contemplated that, the steering wheel could be disposed in front of the right seat 18. The steering assembly 16 is operatively connected to the two front wheels 14 to permit steering of the RUV 10. An internal combustion engine 29, shown schematically in FIG. 3, is mounted to the middle portion 12B of frame 12 between the right and the left seats 18. It is contemplated that the engine 29 could be replaced by another type of motor, such as an electric motor. The engine 29 is operatively connected to the four wheels 14 to power the RUV 10. It is contemplated that the engine 29 could be operatively connected only to the front wheels 14 or only to the rear wheels 14. A cargo box 11 is pivotally mounted to the frame 12 rearward of the seats 18. It is contemplated that the cargo box 11 could be omitted. A console 23, positioned between the right and left seats 18, covers and separates the engine 29 from the driver and the passenger. The RUV 10 has other features and components such as headlights and handles not described herein for simplicity.

The left flexible lateral cover 40 selectively covering the left lateral passage 24 of the RUV 10 will now be described with reference to FIG. 1. The right flexible lateral cover 40 selectively covering the right lateral passage 24 is a mirror image of left flexible lateral cover 40 and as such will not be described in detail herein.

The lateral cover 40 has a generally triangular shaped body. The upper part of the lateral cover 40 connects to the roll cage 30 via two upper attachment points 45. At its lower rear part, the lateral cover 40 connects to the frame 12 via a lower attachment point 43. At its front, the lateral cover 40 selectively connects to the frame 12 via a forward attachment point 41. The lateral cover 40 extends forwardly and downwardly from the upper attachment points 45 to the forward attachment point 41, and extends forwardly and upwardly from the lower attachment point 43 to the forward attachment point 41. One of the upper attachment points 45 is located longitudinally between the lower attachment point 43 and the forward attachment point 41. It is contemplated that the lateral cover 40 could be connected to the roll cage 30 at one or more than two attachment points 45. It is contemplated that two or more lower attachment points 43 could be used to connect the lower rear part of the lateral cover 40 to the frame 12. It is contemplated that the two upper attachment points 45 could be located longitudinally between the lower attachment point 43 and the forward attachment point 41. It is also contemplated that the lower attachment point 43 could be located longitudinally between the two upper attachment points 45 and the forward attachment point 41.

Two additional attachment points 47 connect the lateral cover 40 to the lateral restraining member 36. It is contemplated that only one or more or no additional attachment points 47 could be used to secure the lateral cover 40 to the RUV 10. It is also contemplated that the additional attachment points 47 could connect to the roll cage 30.

The lateral cover 40 is mounted to the RUV 10 via strap holders which are fixed to the roll cage 30 via nuts and bolts at the attachment points 43 and 45, and via tubes formed in the straps at the additional attachment points 47. It is contemplated that the lateral cover 40 could be mounted to the RUV 10 by other means.

The lateral cover 40 is selectively disposed across the lateral passage 24 via the forward attachment point 41. A buckle 50 at the forward attachment point 41 is used to selectively close the lateral cover 40. To open and close the lateral cover 40 the rider disconnects and connects, respectively, the buckle 50 by inserting his fingers into an aperture 53.

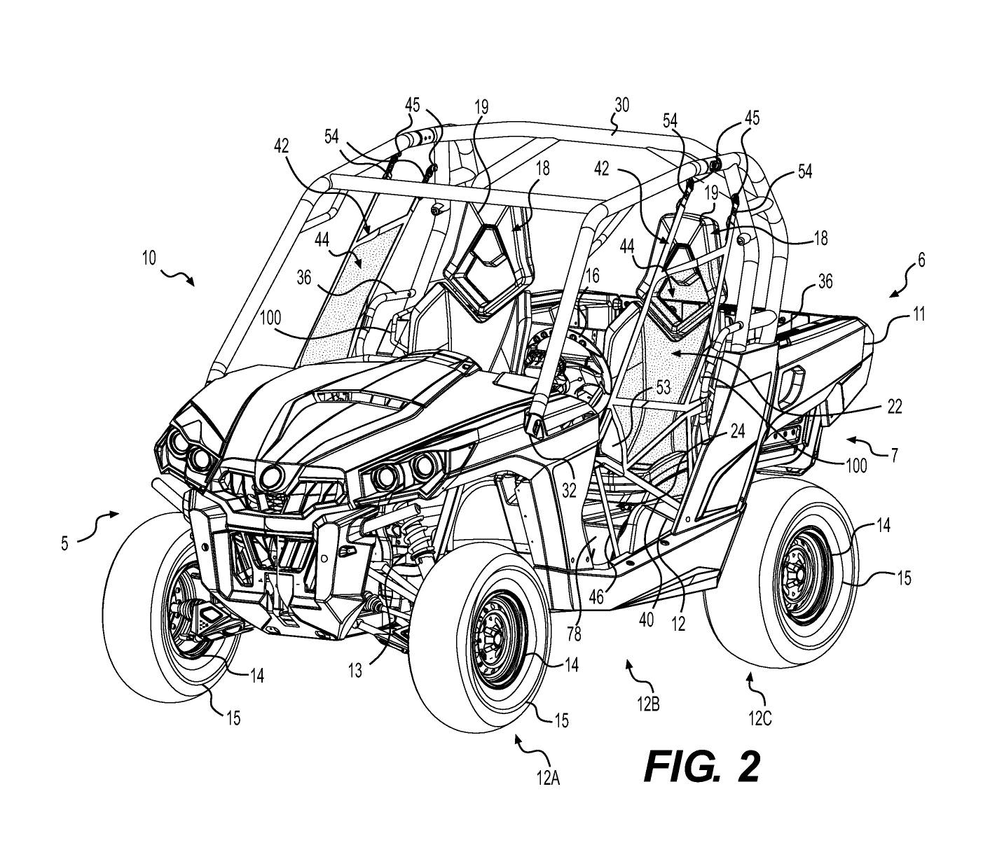

The generally triangular shaped body of the lateral cover 40 is made of a plurality of flexible straps 42 and flexible panels 44 of mesh material (schematically illustrated with stippled shading in FIGS. 1 and 2). The flexible straps 42 are polyester straps dimensioned so that the lateral cover 40 is disposed tightly across the lateral passage 24. The flexible straps 42 are flexible enough to move freely downwards by gravity when the lateral cover 40 is not disposed across the lateral passage 24. It is contemplated that the flexible straps 42 could be made of a different material.

Strap adjusters 54 allow the adjustment of a length of some of the flexible straps 42, and therefore to adjust a tension in these flexible straps 42. It is contemplated that the strap adjusters 54 could be omitted.

A flexible strap 46, separate from the lateral cover 40, connects the lateral cover 40 to an attachment point 51. The flexible strap 46 is a strap that provides an additional retention means for the feet of the riders. The flexible strap 46 extends from the forward attachment point 41 to the attachment point 51. The attachment point 51 is located longitudinally forward of the lower attachment point 43 and longitudinally rearward of the forward attachment point 41. It is contemplated that the flexible strap 46 could be omitted. It is also contemplated that the flexible strap 46 could be part of the lateral cover 40 and be connected to the lateral cover 40 by a flexible panel 44.

The arrangement of the plurality of flexible straps 42 defines areas where the flexible panels 44 are disposed thereon. It is also contemplated that the flexible straps 42 could define only zones where a flexible panel should be disposed thereon, and that the flexible panel 44 would be a single flexible panel covering the zones defined by the flexible straps 42.

The flexible panels 44 are made of 200 denier nylon. The flexible panels 44 are dimensioned so that the lateral cover 40 is disposed tight across the lateral passage 24. The flexible panels 44 are made of a meshed material that allows the driver and the passenger to see through it and let wind blow through.

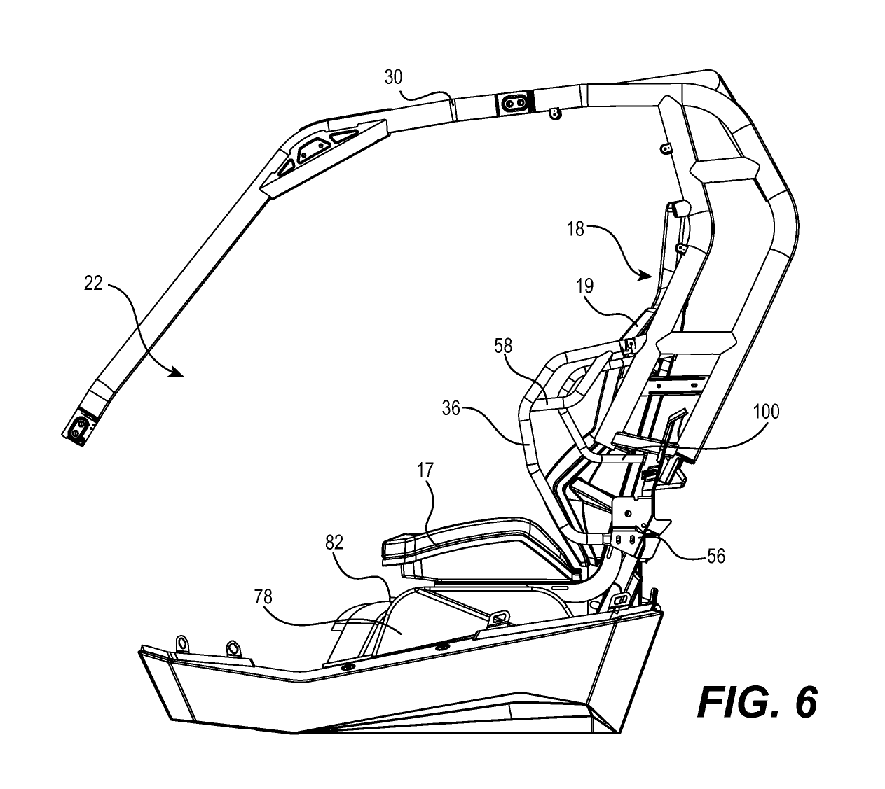

With reference to FIG. 6, the left lateral restraining member 36 will be described in more detail. The right lateral restraining member 36 is a mirror image of the left lateral restraining member 36 and for simplicity will not be described in detail herein.

The lateral restraining member 36 is a metal tube having an upper end fixed to the roll cage 30 by fasteners (not shown). From its upper end, the lateral restraining member 36 extends forwardly, downwardly and laterally outwardly and then rearwardly, downwardly and laterally inwardly to its lower end. As such, the lateral restraining member 36 is generally U-shaped. The lower end of the lateral restraining member 36 is fixed to a bracket 56 of the frame 12 by fasteners (not shown). It is contemplated that the upper and lower ends of the lateral restraining member 36 could be fixed to the roll cage 30 and frame 12 by means other than fasteners, such as by welding for example. An obtuse V-shaped tube 58 connects to upper portions of the lateral restraining member 36.

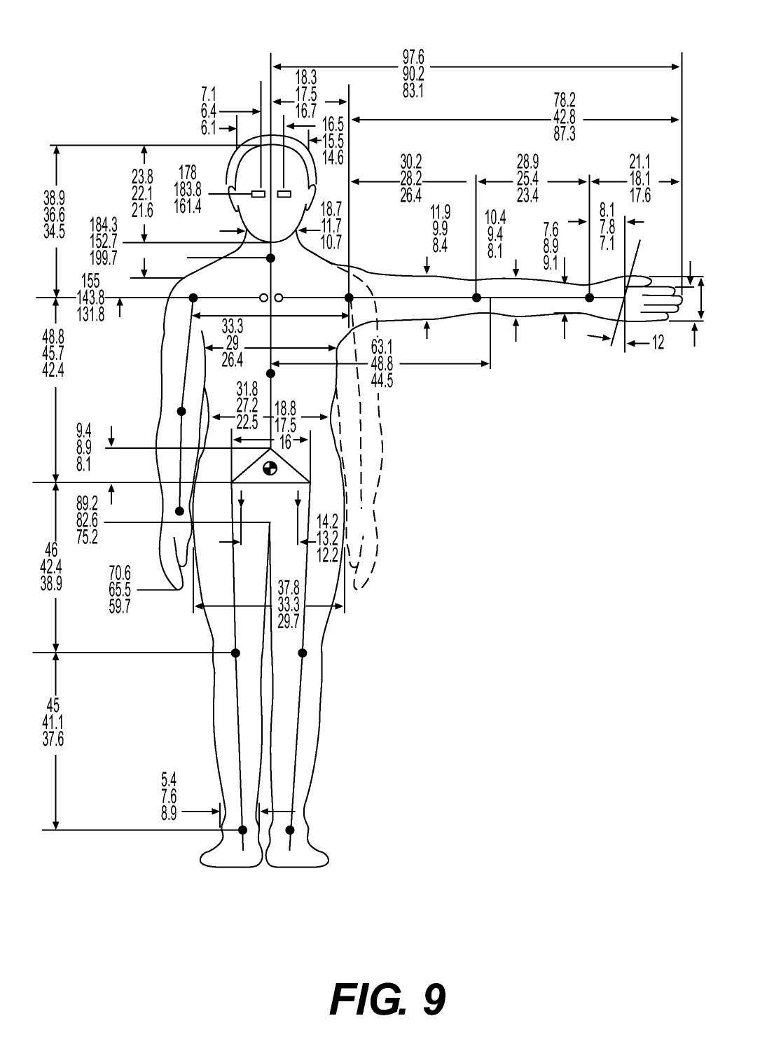

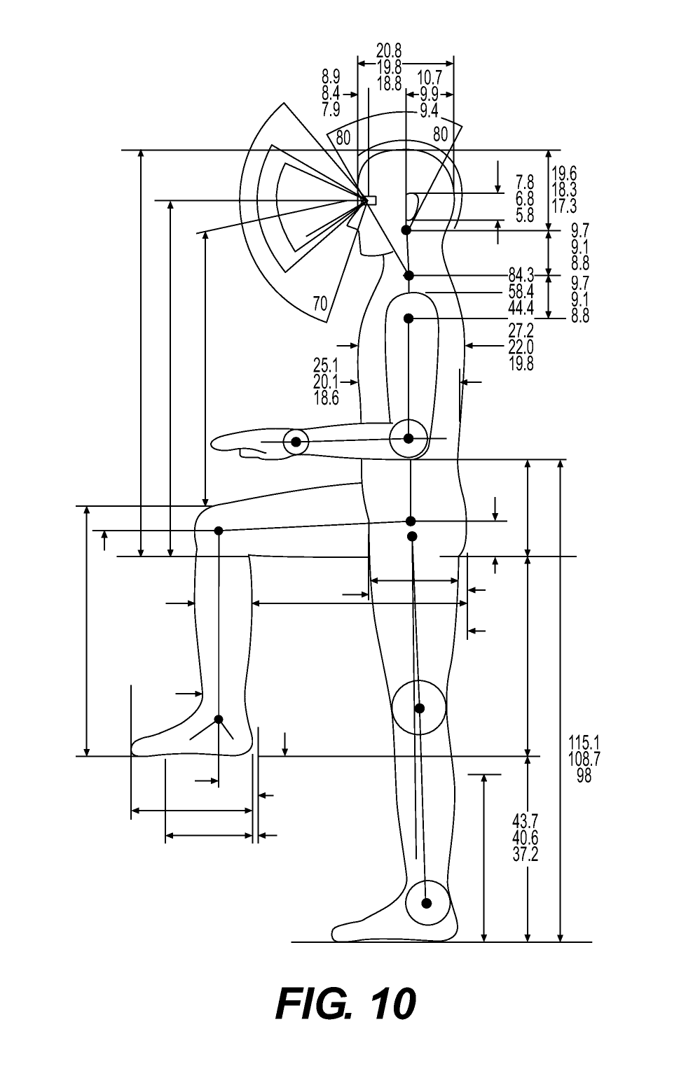

As can be seen in FIG. 1, the upper end of the lateral restraining member 36 is disposed lower than a top of a shoulder of a driver sitting in the seat 18 and corresponding to the 50^{th} percentile North-American adult male. FIGS. 9 and 10 provide various measurements of an adult male in centimeters. For each measurement, three values are provided. The middle value of each set of three values corresponds to the measurement for the 50^{th} percentile North-American adult male. The 50^{th} percentile North-American adult male weighs 78 kg.

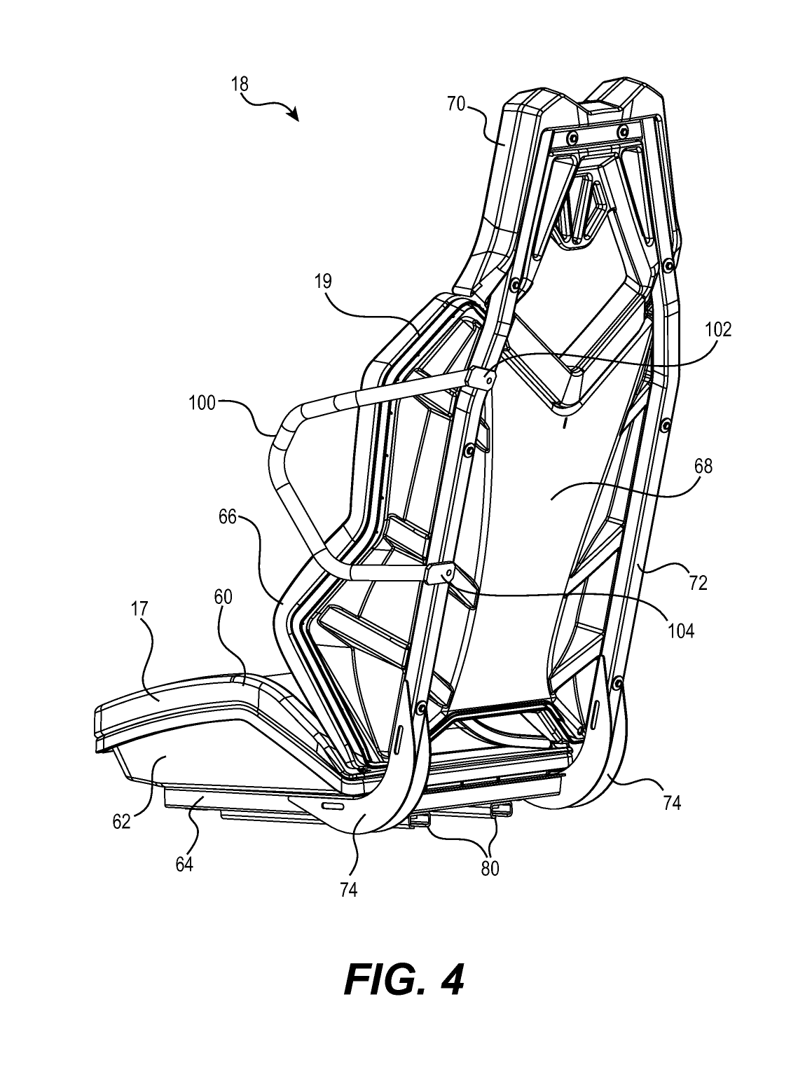

Turning now to FIG. 4, the left seat 18 will be described in greater detail. The right seat is a mirror image of the left seat 18 and for simplicity will not be described in detail herein.

As mentioned above, the seat 18 has a seat base 17 and a backrest 19. The seat base 17 includes a cushion 60 connected on top of a rigid shell 62. A seat base frame 64 is fastened to the bottom of the rigid shell 62. The seat base frame 64 is made of hollow metal tubes with square cross-sections. The backrest 19 includes a cushion 66 connected in front of a rigid shell 68. The seat 18 also has a headrest 70 disposed above top part of the cushion 66.

A backrest frame 72 is fastened to the back of the rigid shell 68. The backrest frame 72 is made of hollow metal tubes with square cross-sections. The cushions 60 and 66 are concave so as to provide some lateral support to a rider sitting on the seat 18. The backrest frame 72 is connected to the seat base frame 64 by a pair of brackets 74. The brackets 74 position the backrest 19 at a fix angle that is slightly greater than 90 degrees. It is contemplated that the backrest frame 72 could be connected to the seat base frame 64 by a mechanism permitting the adjustment of the angle between the backrest 19 and the seat base 17.

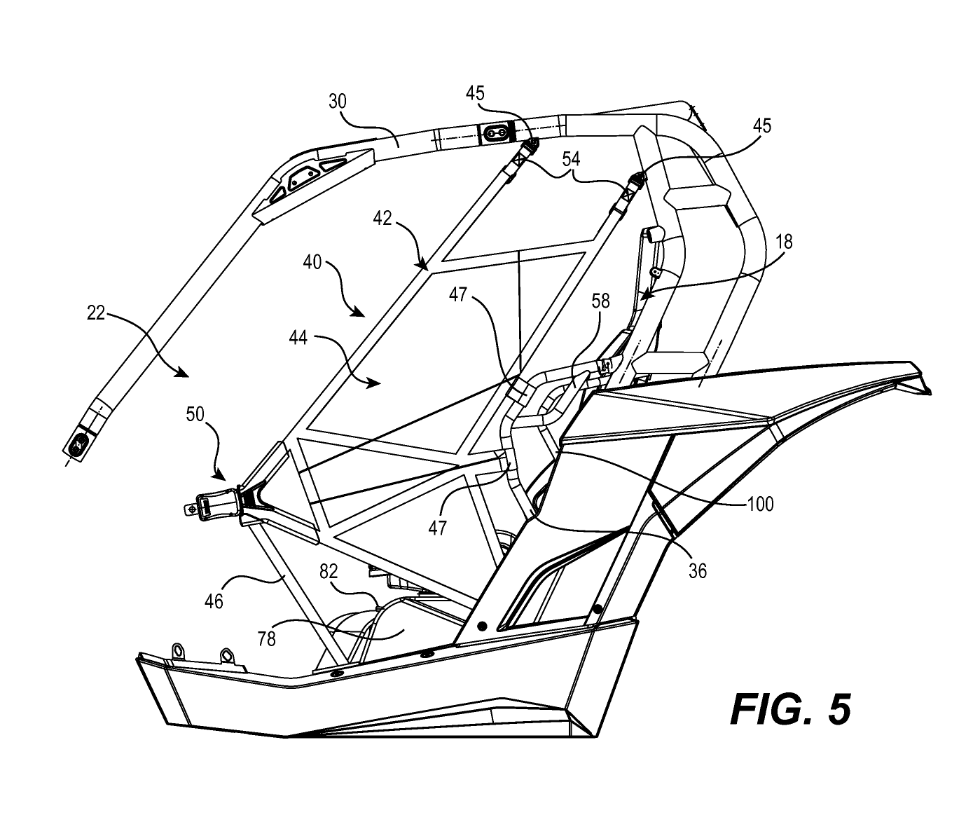

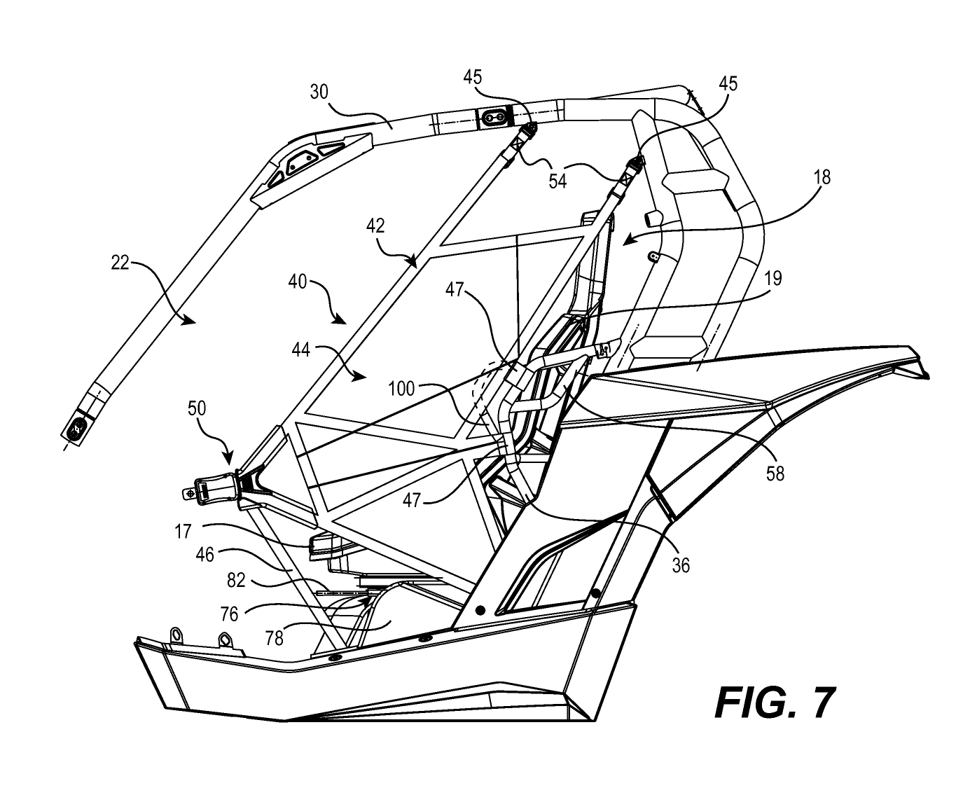

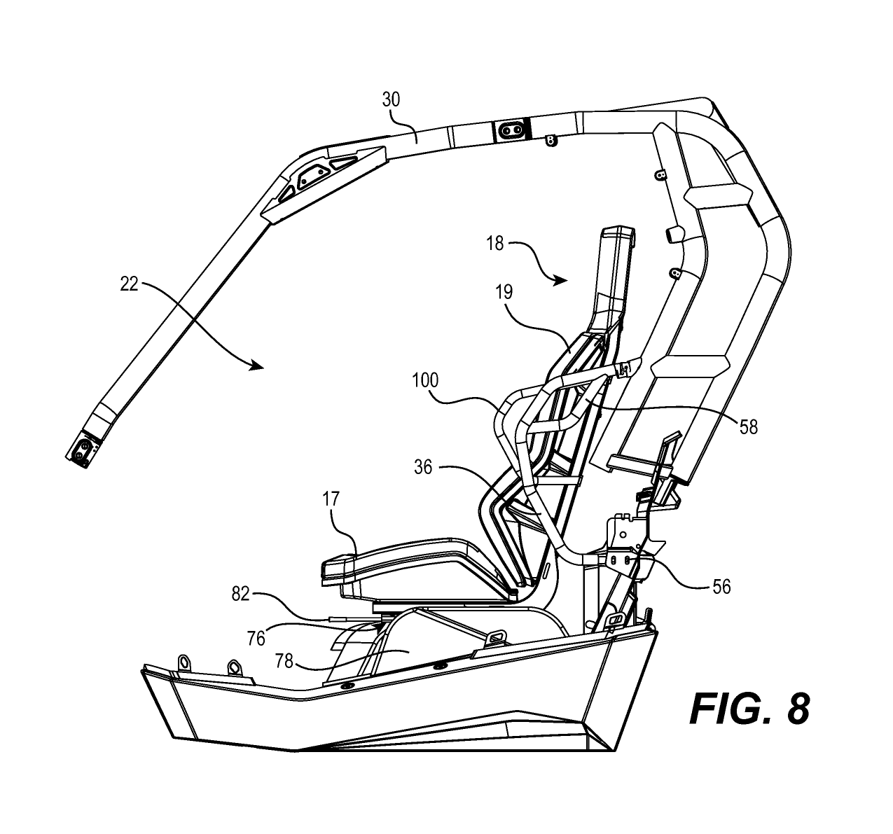

A seat adjustment mechanism 76 (FIG. 7) is connected between the seat base frame 64 and a raised portion 78 of a floor of the cockpit area 22. The seat adjustment mechanism 76 allows the seat 18 to be moved forward and backward along a longitudinal direction of the RUV 10 between a rearmost position shown in FIGS. 5 and 6 and a forwardmost position shown in FIGS. 7 and 8. The seat 18 can be positioned at these positions and at a number of positions intermediate these two positions. The seat adjustment mechanism 76 includes a pair of rails 80 (FIG. 4) connected to the bottom of the seat base frame 64. The rails 80 are disposed around slide members (not shown) having a plurality of holes. Each hole corresponds to a longitudinal position of the seat 18. A latch member (not shown) selectively engages one of the holes to set a position of the seat 18. A lever 82 (FIGS. 7 and 8) is connected to the latch member. The lever 82 extends close to a front of the seat base 17 so as to be easily actuated by a rider sitting on the seat 18 to disengage the latch member so as to allow adjustment of a longitudinal position of the seat 18. U.S. Pat. No. 4,726,617, issued Feb. 23, 1988, the entirety of which is incorporated herein by reference, describes a seat adjustment mechanism similar to the seat adjustment mechanism 76. It is contemplated that other types of seat adjustment mechanisms could be used. For example, the seat adjustment mechanism could include an electric motor that turns a screw that moves the seat 18 forward or back depending on the direction of rotation of the screw. With such a mechanism, the rider sitting on the seat 18 actuates switches to move the seat forward or back. The positions of the left and right seats 18 can be adjusted independently from each other.

A left lateral restraining member 100 is fixed to the left seat 18 so as to be disposed on a left side thereof. Similarly, a right lateral restraining member 100 is fixed to the right seat 18 so as to be disposed on a right side of the seat. Therefore, the lateral restraining members 100 move forward and back with their respective seats 18. As can be seen in FIG. 3, the left lateral restraining member 100 is disposed laterally between the left seat 18 and the left lateral restraining member 36. Similarly, the right lateral restraining member 100 is disposed laterally between the right seat 18 and the right lateral restraining member 36. The lateral restraining members 100 are metal tubes.

Additional features of the left lateral restraining member 100 will now be described with respect to the left seat 18 and the left lateral restraining member 36. As the right lateral restraining member 100, the right seat 18 and the right lateral restraining member 36 are mirror images of the left lateral restraining member 100, the left seat 18 and the left lateral restraining member 36, for simplicity the corresponding features of the right lateral restraining member 100 will not be described in detail herein.

As can be seen in FIG. 4, the upper and lower ends 102, 104 of the left lateral restraining member 100 are fixed to the back of a left side tube of the backrest frame 72 via fasteners (not shown). It is contemplated that the lateral restraining member 100 could be fixed to the rigid shell 68 of the backrest 19. The lateral restraining member 100 is disposed lower than the headrest 70 such that a top of the lateral restraining member 100 is lower than a top of a shoulder of a 50^{th} percentile North-American adult male sitting on the seat 18, as can be seen in FIG. 1. The upper end 102 of the lateral restraining member 100 is disposed above the vertical center of the backrest 19. In one embodiment, the upper end 102 of the lateral restraining member 100 is disposed at less than 52 centimeters above a top rear portion of the seat base 17. From its upper end 102, the lateral restraining member 100 extends forwardly, downwardly and laterally outwardly to a point higher than the seat base 17 and forward of the backrest 19. From this point, the lateral restraining member 100 extends rearwardly, downwardly and laterally inwardly to its lower end 104. The lower end 104 of the lateral restraining member 100 is disposed below the vertical center of the backrest 19. As can be seen, the lateral restraining member 100 is generally U-shaped.

As best seen in FIG. 6, the lateral restraining member 100 is smaller than the lateral restraining member 36. The height of the lateral restraining member 36 is greater than the height of the lateral restraining member 100. The height of the lateral restraining members 36, 100 is measured vertically from their respective vertically lowest points to their respective vertically highest points. The length of the lateral restraining member 36 is greater than the length of the lateral restraining member 100. The length of the lateral restraining members 36, 100 is measured horizontally from their respective longitudinally forwardmost points to their respective longitudinally rearmost points. As can be seen in FIG. 6, the lateral restraining member 100 is small enough that when the seat 18 is in its rearmost position, a projection of the lateral restraining member 100 on a longitudinally extending vertical plane (the drawing page on which FIG. 6 appears corresponding to such a plane) is disposed inwardly of a projection of the lateral restraining member 36 on the longitudinally extending vertical plane. It is contemplated that the lateral restraining member 100 could be larger than illustrated. It is also contemplated that the lateral restraining member 100 could be as large as or even larger than the lateral restraining member 36 in height and/or in length. Also, as can be seen in FIG. 5, when the seat 18 is in its rearwardmost position and the flexible lateral cover 40 is connected at its forward attachment point 41 so as to extend across the lateral passage 24, a front portion of a projection of the lateral restraining member 100 on a longitudinally extending vertical plane (the drawing page on which FIG. 5 appears corresponding to such a plane) is outside of a periphery of a projection of the flexible lateral cover 40 on this plane.

As can be seen in FIGS. 5 and 6, when the seat 18 is in its rearmost position, a majority of the lateral restraining member 36 is disposed forward of the backrest 19 and a front end of the lateral restraining member 36 is disposed forward of a front end of the lateral restraining member 100. As can be seen in FIGS. 7 and 8, when the seat 18 is in its forwardmost position, a smaller portion of the lateral restraining member 36 is disposed forward of the backrest 19 and a front end of the lateral restraining member 36 is disposed rearward of a front end of the lateral restraining member 100. Also, as can be seen in FIG. 7, when the seat 18 is in its forwardmost position and the flexible lateral cover 40 is connected at its forward attachment point 41 so as to extend across the lateral passage 24, a front portion (shown in dotted lines) of a projection of the lateral restraining member 100 on a longitudinally extending vertical plane (the drawing page on which FIG. 7 appears corresponding to such a plane) overlaps a portion of a projection of the flexible lateral cover 40 on this plane.

Modifications and improvements to the above-described embodiment of the present technology may become apparent to those skilled in the art. The foregoing description is intended to be exemplary rather than limiting. The scope of the present technology is therefore intended to be limited solely by the scope of the appended claims.

What is claimed is:

1. A vehicle comprising:
a frame;
at least three wheels connected to the frame;
a motor supported by the frame and operatively connected to at least one of the wheels;
a cockpit area defined in the frame;
a seat disposed in the cockpit area, the seat having a seat base and a backrest, the seat being movable along a longitudinal direction of the vehicle between a first position and a second position, the first position being closer to a front of the vehicle than the second position; and
a lateral restraining member fixed to the seat on one side of the seat, at least a portion of the lateral restraining member being disposed higher than the seat base and forward of the backrest, the lateral restraining member being movable with the seat between the first and second positions.

2. The vehicle of claim 1, wherein the lateral restraining member is fixed to the backrest.

3. The vehicle of claim 2, wherein the backrest includes a backrest frame and a cushion connected to the backrest frame; and
wherein the lateral restraining member is connected to the backrest frame.

4. The vehicle of claim 1, wherein the seat has a headrest disposed above the backrest; and
wherein the lateral restraining member is disposed lower than the headrest.

5. The vehicle of claim 1, wherein the portion of the lateral restraining member being disposed above the seat base and forward of the backrest has a portion disposed above a vertical center of the backrest and another portion disposed below the vertical center of the backrest.

6. The vehicle of claim 1, wherein the lateral restraining member is a first lateral restraining member;
the vehicle further comprising a second lateral restraining member fixed to the frame, the second lateral restraining member being disposed on the one side of the seat, the first lateral restraining member being disposed at least in part laterally between the seat and the second lateral restraining member.

7. The vehicle of claim 6, wherein a height of the second lateral restraining member is greater than a height of the first lateral restraining member.

8. The vehicle of claim 6, wherein a length of the second lateral restraining member is greater that a length of the first lateral restraining member.

9. The vehicle of claim 6, wherein at least a portion of the second lateral restraining member is disposed forward of the backrest when the seat is in the first position.

10. The vehicle of claim 6, wherein a front end of the second lateral restraining member is disposed forward of a front end of the first lateral restraining member when the seat is in the second position; and
wherein the front end of the second lateral restraining member is disposed rearward of the front end of the first lateral restraining member when the seat is in the first position.

11. The vehicle of claim 6, further comprising a roll cage connected to the frame, the roll cage covering at least in part the cockpit area; and
wherein an upper end of the second lateral restraining member is connected to the roll cage and a lower end of the second lateral restraining member is connected to the frame.

12. The vehicle of claim 1, wherein the lateral restraining member is a generally U-shaped tube.

13. The vehicle of claim 1, further comprising two lateral sides, the cockpit area being disposed between the two lateral sides, at least the lateral side on the one side of the seat defining a lateral passage adapted to allow ingress and egress of a rider to and from the cockpit area.

14. The vehicle of claim 13, further comprising:
a roll cage connected to the frame, the roll cage covering at least in part the cockpit area; and
a lateral flexible cover selectively extending at least partially across the lateral passage defined by the lateral side on the one side of the seat, the lateral flexible cover being connected to the roll cage.

15. The vehicle of claim 14, wherein when the seat is in the first position and the lateral flexible cover extends across the lateral passage, a portion of a projection of the lateral restraining member on a longitudinally extending vertical plane overlaps a portion of a projection of the lateral flexible cover on the longitudinally extending vertical plane.

16. The vehicle of claim 1, wherein the seat is a left seat and the one side of the seat is the left side of the seat;
wherein the lateral restraining member is a left lateral restraining member;
the vehicle further comprising:
a right seat disposed in the cockpit area to a right of the left seat, the right seat having a seat base and a backrest, the right seat being movable along the longitudinal direction of the vehicle between a third position and a fourth position, the third position being closer to the front of the vehicle than the fourth position;
a right lateral restraining member fixed to the seat on the right side of the seat, at least a portion of the right lateral restraining member being disposed above the seat base of the right seat and forward of the backrest of the right seat, the right lateral restraining member being movable with the seat between the third and fourth positions; and
a steering device disposed in front of one of the left and right seats, the steering device being operatively connected to at least one of the wheels.

17. The vehicle of claim 1, wherein the at least three wheels is two front wheels and two rear wheels.

18. The vehicle of claim 6, wherein a projection of the first lateral restraining member on a longitudinally extending vertical plane when the seat is in the second position is disposed inwardly of a projection of the second lateral restraining member on the longitudinally extending vertical plane.

19. The vehicle of claim 1, wherein the lateral restraining member is fixed to the seat at a position where a top of the lateral restraining member is vertically lower than a top of a shoulder of a 50^{th} percentile North-American adult male sitting on the seat.

20. The vehicle of claim 1, where a top of the lateral restraining member is less than 52 centimeters above a top rear portion of the seat base.
